(19) United States
(12) Patent Application Publication
(10) Pub. No.: US 2026/0321182 A1
(43) Pub. Date: Oct. 15, 2026

(54) DATA DRIVING DEVICE, AND DISPLAY APPARATUS INCLUDING THE SAME

(71) Applicant: LX SEMICON CO., LTD., Daejeon (KR)

(72) Inventors: Sung Wan JUNG, Daejeon (KR); Hyeonju JEONG, Daejeon (KR); Mingu KIM, Daejeon (KR); Doo Hoe KIM, Daejeon (KR)

(73) Assignee: LX SEMICON CO., LTD., Daejeon (KR)

(21) Appl. No.: 19/642,188

(22) Filed: Apr. 8, 2026

(30) Foreign Application Priority Data
Apr. 9, 2025 (KR) 10-2025-0046281

(51) Int. Cl. G09G 3/20

(52) U.S. Cl. CPC G09G 3/2092; G09G 2300/0814; G09G 2310/0275; G09G 2310/0297

(57) ABSTRACT

A data driving device according to an embodiment of the present disclosure includes: a plurality of data driving circuits, wherein each of the plurality of data driving circuits includes: a clock recovery unit configured to recover display data and an internal system clock from image data received from a timing controller, and generate a plurality of candidate reference clocks having a predetermined phase difference using the internal system clock; and a data processing unit configured to calculate a timing difference between a clock training symbol of the display data and the internal system clock, and generate an output clock synchronized with another data driving circuit based on the calculated timing difference between the clock training symbol and the internal system clock.

### CROSS-REFERENCE TO RELATED APPLICATIONS

This application claims the benefit of the Korean Patent Application No. 10-2025-0046281 filed on Apr. 9, 2025 which is hereby incorporated by reference as if fully set forth herein.

### BACKGROUND

### Field of the Invention

The present disclosure relates to a data driving device and a display apparatus including the same.

### Discussion of the Related Art

In general, a display apparatus is configured such that a timing controller transmits display data to a display driving circuit, the display driving circuit outputs a source signal corresponding to the display data, and a display panel displays an image in response to the source signal.

The display data transmitted from the timing controller to the data driving device is composed of packets. The display data may include data corresponding to information for display and a clock for driving the data.

The data driving device may include a plurality of display driving circuits (D-IC #1 to #N). When power is turned on (Power On), each display driving circuit recovers display data and an internal system clock (SCLK) from image data (DATA) (CDR LOCK Time), performs a data processing process using the recovered clock, and outputs a source signal as a result. At this time, the output timing of the source signal may be determined using the recovered clock. The display driving circuits (D-IC #1 to #3) may define a LOCK state when the recovered internal system clock (SCLK) is normal and an Unlock state when the clock is abnormal, and are configured to generate and output a lock signal for indicating the state of the internal system clock (SCLK).

As shown in FIG. 1, each of the plurality of display driving circuits generates the internal system clock (SCLK) at different timings (\textcircled{2}) due to internal lock signals (LOCK) that become a high signal (H) at different timings (\textcircled{1}). Accordingly, a source output signal (SOE) becomes a high signal (H) at different timings (\textcircled{3}), so that source signals (SS) are output at different timings (\textcircled{4}), which may cause a difference in voltage output to the display panel (\textcircled{5}). Therefore, the quality of an image displayed on the display panel may be deteriorated.

### SUMMARY

The present disclosure is directed to solve the above-described problems, and an object of the present disclosure is to provide a data driving device in which source signals are output at the same timing from display driving circuits, and a display apparatus including the same.

A data driving device according to an embodiment of the present disclosure includes: a plurality of data driving circuits, wherein each of the plurality of data driving circuits includes: a clock recovery unit configured to recover display data and an internal system clock from image data received from a timing controller, and generate a plurality of candidate reference clocks having a predetermined phase difference using the internal system clock; and a data processing unit configured to calculate a timing difference between a clock training symbol of the display data and the internal system clock, and generate an output clock synchronized with another data driving circuit based on the calculated timing difference between the clock training symbol and the internal system clock.

A display apparatus according to an embodiment of the present disclosure includes: a display panel configured to receive a source signal and display an image; and a data driving device including a plurality of data driving circuits configured to simultaneously supply the source signal to the display panel, wherein each of the plurality of data driving circuits includes: a clock recovery unit configured to recover display data and an internal system clock from image data received from a timing controller, and generate a plurality of candidate reference clocks having a predetermined phase difference using the internal system clock; and a data processing unit configured to calculate a timing difference between a clock training symbol of the display data and the internal system clock, and generate an output clock synchronized with another data driving circuit based on the calculated timing difference between the clock training symbol and the internal system clock.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a timing diagram of signals processed in a conventional data driving circuit.

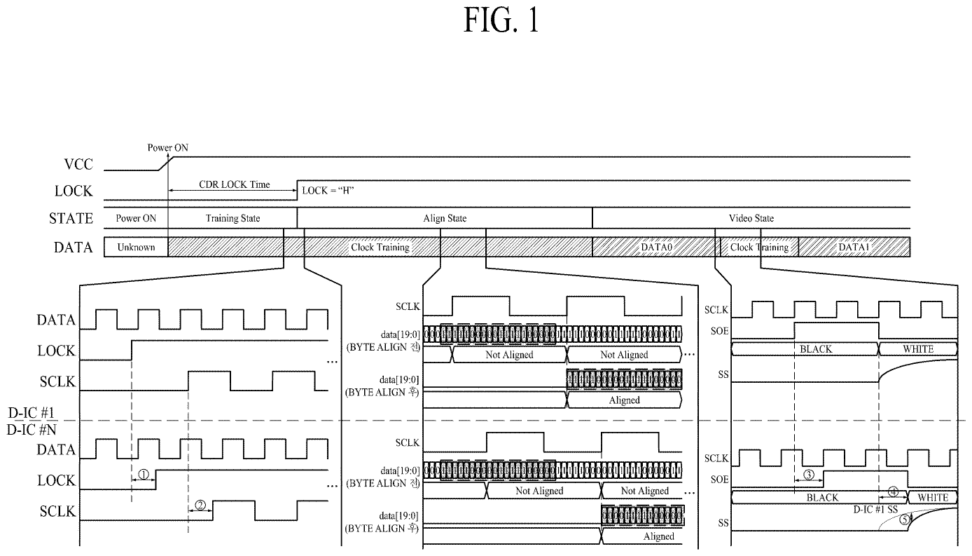

FIG. 2 is a simplified block diagram of a display apparatus according to an embodiment of the present disclosure.

FIG. 3 is a simplified block diagram of a data driving circuit according to an embodiment of the present disclosure.

FIG. 4 is a timing diagram of signals output from a clock recovery unit of a data driving circuit according to an embodiment of the present disclosure.

FIG. 5 is a diagram illustrating a clock selection signal determined according to data and an internal system clock in a data processing unit according to an embodiment of the present disclosure.

FIG. 6 is a diagram illustrating a process of generating a clock selection signal in a data processing unit of a data driving circuit according to an embodiment of the present disclosure.

FIG. 7 is a simplified block diagram of a source output signal synchronizer according to an embodiment of the present disclosure.

FIG. 8 is a timing diagram illustrating a step of determining a reference clock of a source output signal synchronizer according to an embodiment of the present disclosure.

FIG. 9 is a timing diagram of an input signal and an output signal of a source output signal synchronizer according to an embodiment of the present disclosure.

FIG. 10 is a diagram comparing input and output data for conventional data driving circuits and a data driving circuit according to an embodiment of the present disclosure.

### DETAILED DESCRIPTION OF THE DISCLOSURE

Advantages and features of the present disclosure, and methods for achieving them, will become apparent with reference to the embodiments described below in detail in conjunction with the accompanying drawings. However, the present disclosure is not limited to the embodiments disclosed below, but will be implemented in various different forms. These embodiments are provided only to make the disclosure of the present disclosure complete, and to fully inform those skilled in the art of the scope of the invention, and the present disclosure is only defined by the scope of the claims.

Throughout the specification, the same reference numerals refer to substantially the same components. In the following description, detailed descriptions of components and functions known in the art may be omitted if they are not related to the core configuration of the present disclosure.

When the terms “comprise,” “have,” “consist of,” and the like are used herein, other parts may be added unless the term “only” is used. When a component is expressed in the singular, it includes the plural unless explicitly stated otherwise.

In interpreting the components, it is construed as including an error range even if there is no separate explicit description.

Terms such as first, second, etc., are used to describe various components, but these components are not limited by these terms. These terms are only used to distinguish one component from another component. Therefore, a first component mentioned below may be a second component within the technical spirit of the present disclosure.

The term “at least one” should be understood to include all possible combinations presented from one or more related items. For example, the meaning of “at least one of a first item, a second item, and a third item” may mean not only the first item, the second item, or the third item respectively, but also a combination of all items that can be presented from two or more among the first item, the second item, and the third item.

Each feature of the various embodiments of the present disclosure may be partially or entirely combined or combined with each other, technically various interlocking and driving are possible, and each embodiment may be implemented independently of each other or may be implemented together in an associated relationship.

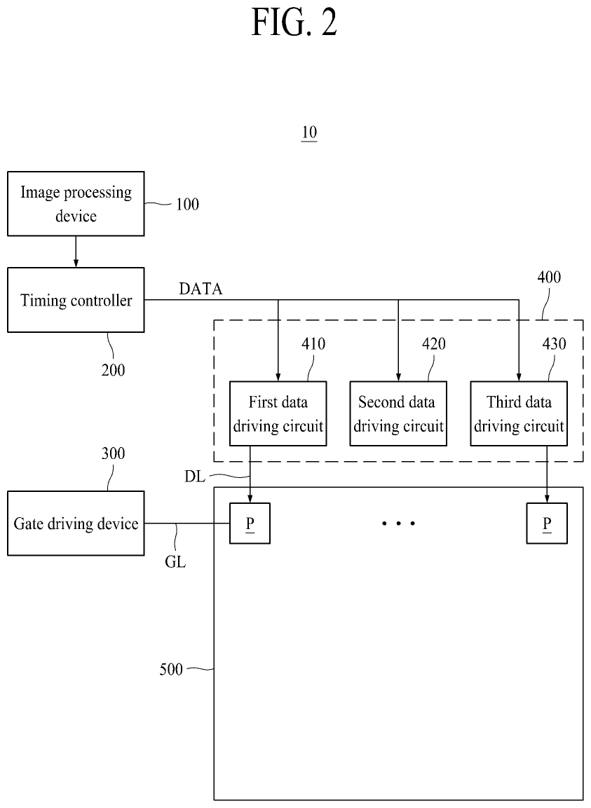

Hereinafter, a display driving circuit and a display apparatus according to an embodiment of the present disclosure will be described with reference to FIG. 2. FIG. 2 is a simplified block diagram of a display apparatus according to an embodiment of the present disclosure.

Referring to FIG. 2, the display apparatus 10 may include a plurality of panel driving devices 100, 200, 300, and 400 and a display panel 500.

A plurality of data lines DL and a plurality of gate lines GL may be disposed, and a plurality of pixels P may be disposed on the display panel 500. The pixel P may include a plurality of sub-pixels. Also, the sub-pixels may be R (red), G (green), B (blue), W (white), and the like. One pixel may include RGB sub-pixels, RGBG sub-pixels, or RGBW sub-pixels. Hereinafter, for convenience of description, it is assumed that one pixel includes RGB sub-pixels.

The panel driving devices 100, 200, 300, and 400 are devices for generating signals for displaying an image on the display panel 500, and an image processing device 100, a timing controller 200, a gate driving device 300, and a data driving device 400 may correspond to the panel driving devices.

The image processing device 100 may generate image data DATA and transmit it to the timing controller 200. The image processing device 100 may be referred to as a host device that provides an image to be displayed by the display panel.

The timing controller 200 may supply control signals to the gate driving device 300 and the data driving device 400. For example, the timing controller 200 may transmit a gate control signal GCS for starting a scan to the gate driving device 300. In addition, the timing controller 200 may receive the image data DATA and output it to the data driving device 400. At this time, the image data DATA may include display data corresponding to an image to be displayed and a clock to be supplied to the display panel 500.

The gate driving device 300 may supply a gate driving signal of a turn-on voltage or a turn-off voltage to the gate line GL. When the gate driving signal of the turn-on voltage is supplied to the pixel P, the pixel P is connected to the data line DL. And, when the gate driving signal of the turn-off voltage is supplied to the pixel P, the connection between the pixel P and the data line DL is released. The gate driving device 300 may be referred to as a gate driver.

The data driving device 400 may supply a data voltage Vp, which is a source signal, to the pixel P through the data line DL. The data driving device 400 may include a plurality of data driving circuits 410, 420, and 430. The data driving circuits 410, 420, and 430 may supply the data voltage Vp, which is a source signal supplied to the data line DL, to the pixel P according to the gate driving signal. The data driving device 400 may be referred to as a source driver, or each of the data driving circuits 410, 420, and 430 may be referred to as a source driver.

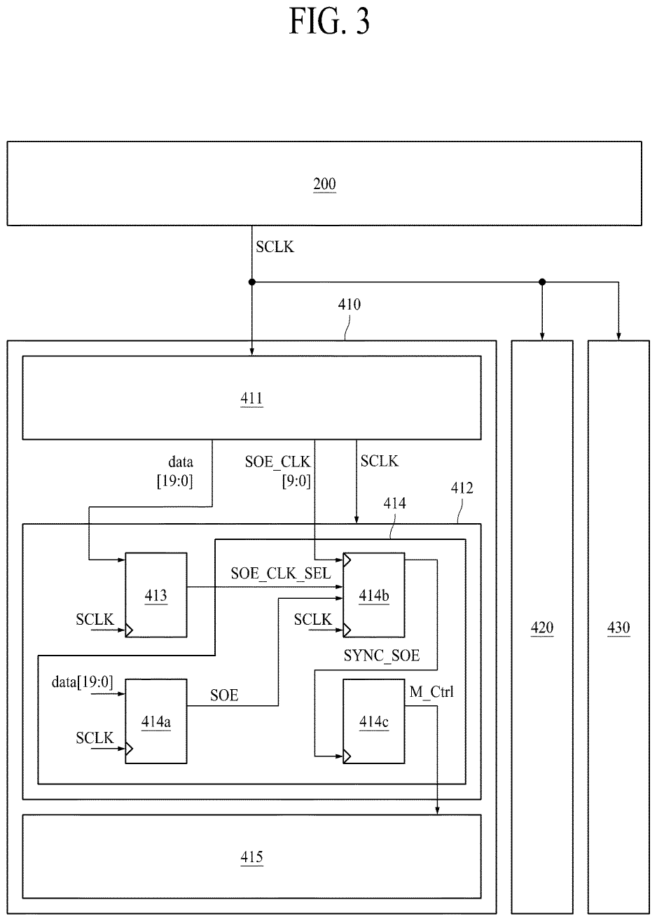

Referring to FIG. 3, the data driving circuits 410, 420, and 430 according to an embodiment of the present disclosure will be described in detail. FIG. 3 is a simplified block diagram of a data driving circuit according to an embodiment of the present disclosure.

Referring to FIG. 3, the data driving circuits 410, 420, and 430 supply the data voltage Vp, which is a source signal, to the pixel P through the data line DL. In particular, according to an embodiment of the present disclosure, different data driving circuits 410, 420, and 430 supply the data voltage Vp, which is a source signal, to corresponding pixels.

To this end, each of the data driving circuits 410, 420, and 430 includes a clock recovery unit 411, a data processing unit 412, and a channel 415, as shown in FIG. 3.

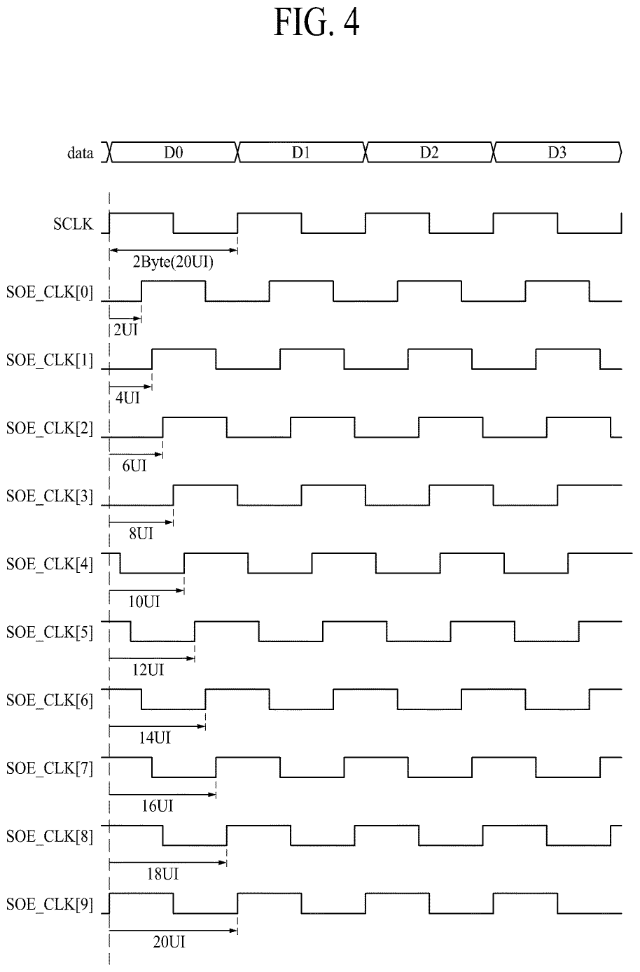

Hereinafter, the clock recovery unit of the data driving circuit according to an embodiment of the present disclosure will be described in detail with reference to FIG. 4. FIG. 4 is a timing diagram of signals output from the clock recovery unit of the data driving circuit according to an embodiment of the present disclosure.

The clock recovery unit 411 recovers the display data data and the internal system clock SCLK from the image data DATA, and latches the display data data based on the recovered internal system clock SCLK. For example, as shown in FIG. 4, the clock recovery unit 411 recovers the internal system clock SCLK and the display data data from the image data DATA, and latches the display data data corresponding to the internal system clock SCLK. At this time, 1 Byte may be 10 UI, and the internal system clock SCLK may be a clock having a cycle of 20 UI (2 Bytes).

To this end, the clock recovery unit 411 may include a phase-locked loop (PLL).

The clock recovery unit 411 may generate and output a plurality of candidate reference clocks having a predetermined phase difference based on the internal system clock SCLK. For example, as shown in FIG. 4, the clock recovery unit 411 may generate and output first to tenth candidate reference clocks SOE_CLK[0] to SOE_CLK[9] having a phase difference of a multiple of 2 UI based on the internal system clock SCLK. That is, the first candidate reference clock SOE_CLK[0] is a clock having a phase difference of 2 UI from the internal system clock SCLK, the second candidate reference clock SOE_CLK[1] is a clock having a phase difference of 2*2 UI from the internal system clock SCLK, and the third candidate reference clock SOE_CLK[2] may be a clock having a phase difference of 3*2 UI from the internal system clock SCLK. Accordingly, the clock recovery unit 411 may generate and output a plurality of candidate reference clocks SOE_CLK[0] to SOE_CLK[9] having a resolution of 2 UI.

However, the phase difference and resolution of the plurality of candidate reference clocks generated by the clock recovery unit 411 are not limited thereto, and the clock recovery unit 411 may generate and output a plurality of candidate reference clocks having various phase differences, and for example, may generate and output first to twentieth candidate reference clocks having a resolution of 1 UI, having a phase difference of a multiple of 1 UI.

The data processing unit 412 detects a predetermined clock training symbol in the display data data, calculates a timing difference between the detected clock training symbol and the internal system clock SCLK, and outputs a synchronized output clock SYNC_SOE to output the data voltage Vp, which is a source signal, at the same time as another data driving circuit.

To this end, the data processing unit 412 includes a clock training symbol detector 413 and a clock synchronizer 414.

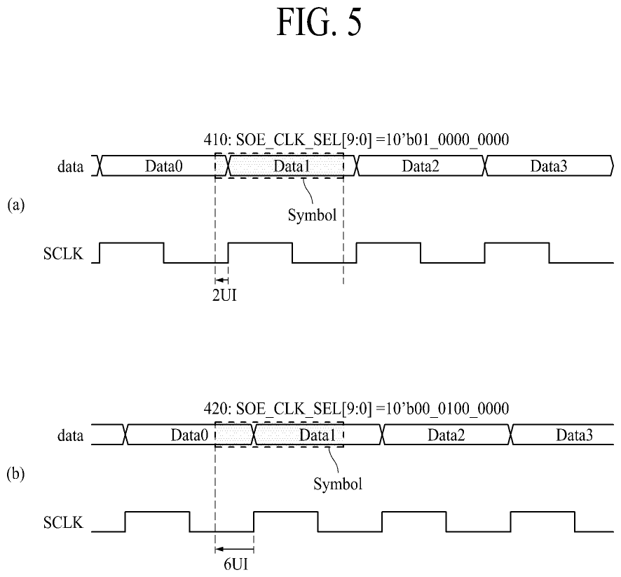

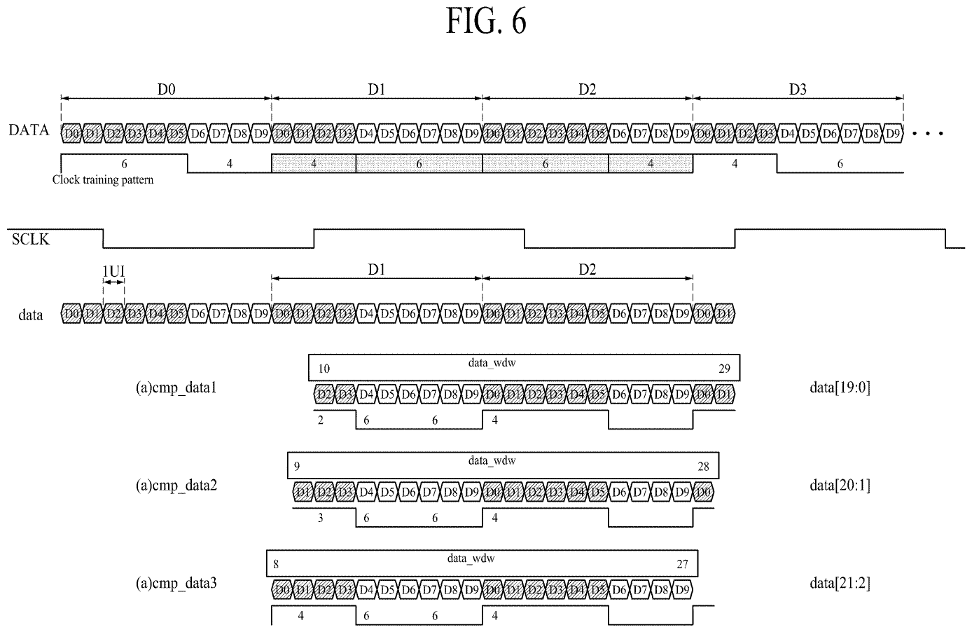

Hereinafter, the clock training symbol detector 413 according to an embodiment of the present disclosure will be described in detail with reference to FIGS. 5 and 6.

As shown in FIG. 5, the clock training symbol detector 413 detects a predetermined clock training symbol in the display data data, generates information on the timing difference between a start point of the clock training symbol in the display data data and a rising edge of the internal system clock SCLK as a clock selection signal SOE_CLK_SEL, and transmits it to the clock synchronizer 414.

For example, as shown in FIG. 5, the clock training symbol detector 413 of the first data driving circuit 410 receives the display data data and the internal system clock SCLK as shown in (a), detects a predetermined clock training symbol in the received display data data, calculates a timing difference (2 UI) between the start point of the detected clock training symbol and the rising edge of the internal system clock SCLK, generates a clock selection signal (SOE_CLK_SEL; 10′b01_0000_0000), and transmits it to the clock synchronizer 414.

Specifically, the clock training symbol detector 413 detects the clock training symbol in the display data data while moving a start point of a data window data_wdw having a predetermined size (e.g., 20 UI) by 1 UI unit in one direction from the rising edge of the internal system clock SCLK, generates the clock selection signal SOE_CLK_SEL using a timing difference between the start point of the data window data_wdw where the clock training symbol is detected and the rising edge of the internal system clock SCLK, and transmits it to the clock synchronizer 414.

That is, as shown in FIG. 6, the clock training symbol detector 413 arranges the start point of the data window data_wdw having a predetermined size (e.g., 20 UI) to correspond to the rising edge of the internal system clock SCLK, and determines whether first comparison data cmp_data1 filtered by the data window data_wdw among the display data data matches the clock training symbol (e.g., HHHHHLLLLLLHHHHHHLLLL).

When the first comparison data cmp_data1 matches the clock training symbol, a clock selection signal (SOE_CLK_SEL; 10′b10_0000_0000) is generated and output based on Table 1 below using a timing difference (0 UI) between the start point of the data window data_wdw filtering the first comparison data cmp_data1 and the rising edge of the internal system clock SCLK.

Meanwhile, when the first comparison data cmp_data1 does not match the clock training symbol, the start point of the data window data_wdw is moved by 1 UI, and it is determined whether second comparison data cmp_data2 filtered by the data window data_wdw matches the clock training symbol.

When the second comparison data cmp_data2 matches the clock training symbol, a clock selection signal (SOE_CLK_SEL; 10′b10_0000_0000) is generated and output based on Table 1 below using a timing difference (1 UI) between the start point of the data window data_wdw filtering the second comparison data cmp_data2 and the rising edge of the internal system clock SCLK.

Meanwhile, when the second comparison data cmp_data1 does not match the clock training symbol, the start point of the data window data_wdw is further moved by 1 UI, and it is determined whether third comparison data cmp_data3 filtered by the data window data_wdw matches the clock training symbol.

When the third comparison data cmp_data3 matches the clock training symbol, a clock selection signal (SOE_CLK_SEL; 10′b01_0000_0000) is generated and output based on Table 1 below using a timing difference (2 UI) between the start point of the data window data_wdw filtering the third comparison data cmp_data3 and the rising edge of the internal system clock SCLK.

TABLE 1

| Shifted UI | SOE_CLK_SEL[9:0] |
|---|---|
| 0 | 10′b10_0000_0000 |
| 1 | |
| 2 | 10′b01_0000_0000 |
| 3 | |
| 4 | 10′b00_1000_0000 |
| 5 | |
| 6 | 10′b00_0100_0000 |
| 7 | |
| 8 | 10′b00_0010_0000 |
| 9 | |
| 10 | 10′b00_0001_0000 |
| 11 | |
| 12 | 10′b00_0000_1000 |
| 13 | |
| 14 | 10′b00_0000_0100 |
| 15 | |
| 16 | 10′b00_0000_0010 |
| 17 | |
| 18 | 10′b10_0000_0001 |
| 19 | |

Referring back to FIG. 3, the clock synchronizer 414 transmits a multiplexer control signal M_Ctrl to the channel 415 to output the source signal simultaneously with other data driving circuits included in the display apparatus 10 using the display data data, the internal system clock SCLK, the clock selection signal SOE_CLK_SEL, and the plurality of candidate reference clocks SOE_CLK[9:0].

To this end, the clock synchronizer 414 includes a source output signal generator 414a, a source output signal synchronizer 414b, and an output controller 414c.

The source output signal generator 414a generates a source output signal SOE using the display data data and the internal system clock SCLK, and transmits it to the source output signal synchronizer 414b. At this time, since the generated source output signal SOE is a signal generated based on the internal system clock SCLK generated at different timings in different data driving circuits, the source output signal SOE may also be a signal generated at different timings in different data driving circuits.

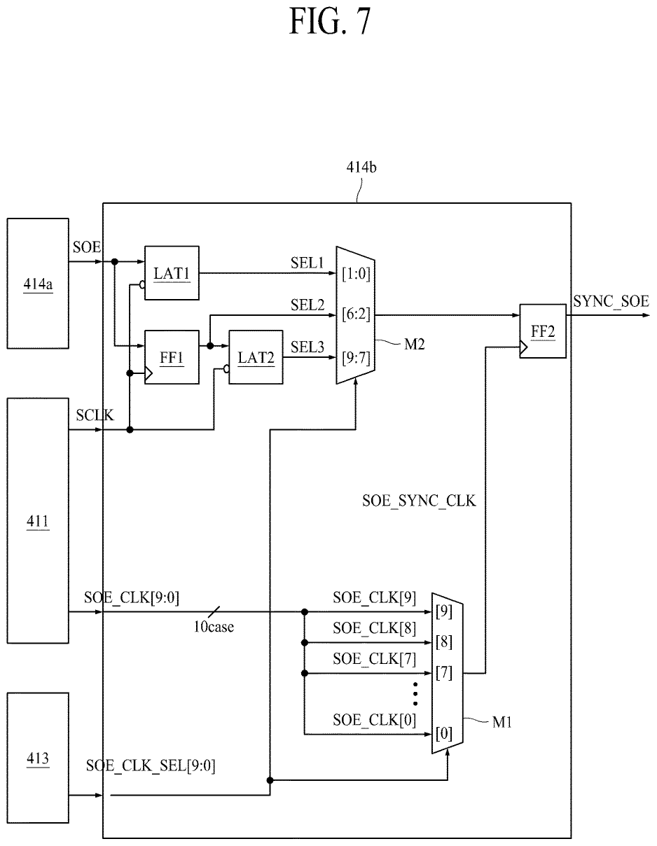

Hereinafter, the source output signal synchronizer according to an embodiment of the present disclosure will be described in detail with reference to FIGS. 7 to 9.

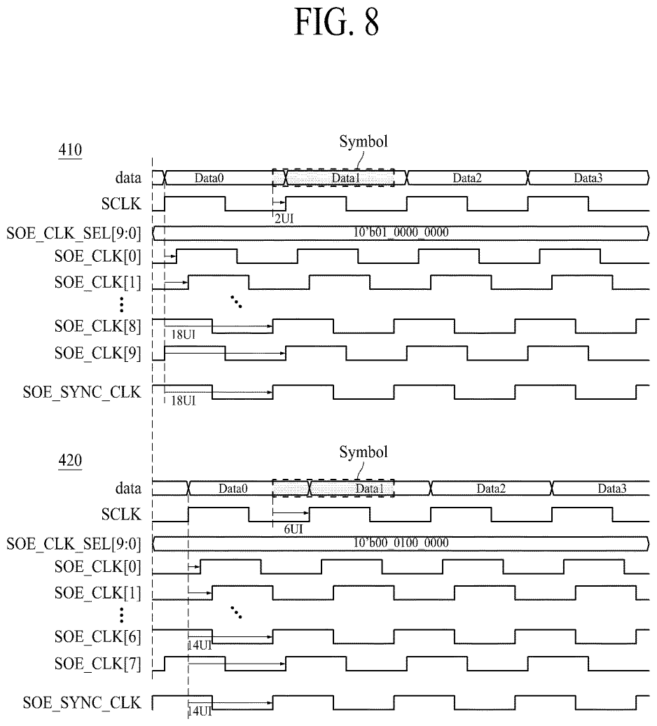

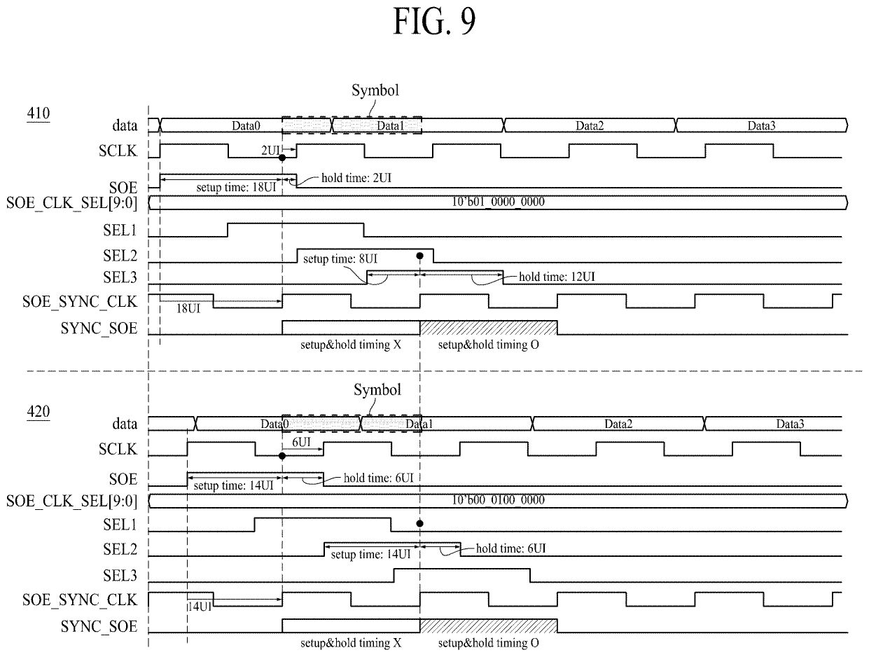

FIG. 7 is a simplified block diagram of a source output signal synchronizer according to an embodiment of the present disclosure, FIG. 8 is a timing diagram illustrating a step of determining a reference clock of the source output signal synchronizer according to an embodiment of the present disclosure, and FIG. 9 is a timing diagram of an input signal and an output signal of the source output signal synchronizer according to an embodiment of the present disclosure.

The source output signal synchronizer 414b generates and outputs a reference clock SYNC_SOE synchronized with another data driving circuit using the source output signal SOE, the internal system clock SCLK, the plurality of candidate reference clocks SOE_CLK[0:9], and the clock selection signal SOE_CLK_SEL[9:0].

To this end, the source output signal synchronizer 414b includes a first multiplexer M1, a first latch LAT1, a first flip-flop FF1, a second latch LAT2, a second multiplexer M2, and a second flip-flop FF2, as shown in FIG. 7.

The first multiplexer M1 outputs any one of the candidate reference clocks SOE_CLK[0:9] received from the clock recovery unit 411 as a synchronization clock SOE_SYNC_CLK based on the clock selection signal SOE_CLK_SEL received from the clock training symbol detector 413.

For example, as shown in FIG. 8, when the timing difference between the start point of the clock training symbol of the display data data received by the first data driving circuit 410 and the rising edge of the internal system clock SCLK is 2 UI, the first multiplexer M1 of the first data driving circuit 410 outputs the ninth candidate reference clock SOE_CLK[8] as the synchronization clock SOE_SYNC_CLK according to the clock selection signal (SOE_CLK_SEL; 10′b01_0000_0000) generated corresponding to the aforementioned timing difference. Meanwhile, when the timing difference between the start point of the clock training symbol of the display data data received by the second data driving circuit 420 and the rising edge of the internal system clock SCLK is 6 UI, the first multiplexer M1 of the second data driving circuit 420 outputs the seventh candidate reference clock SOE_CLK[6] as the synchronization clock SOE_SYNC_CLK according to the clock selection signal (SOE_CLK_SEL; 10′b00_0100_0000) generated corresponding to the aforementioned timing difference.

As shown in FIG. 7, the first latch LAT1 stores the source output signal SOE received from the source output signal generator 414a, and generates a first selection signal SEL1 based on the stored source output signal SOE triggered by the internal system clock SCLK.

Specifically, as shown in FIG. 9, the first latch LAT1 stores a high signal of the source output signal SOE, and generates the first selection signal SEL1 based on the high signal of the source output signal SOE triggered by a falling edge of the internal system clock SCLK. At this time, since the first selection signal SEL1 is a signal generated by triggering the first latch LAT1 by the falling edge of the internal system clock SCLK, it may be a signal obtained by delaying the source output signal SOE by 1 byte (10 UI), that is, 0.5 cycles of the source output signal SOE.

As shown in FIG. 7, the first flip-flop FF1 stores the source output signal SOE received from the source output signal generator 414a, and generates a second selection signal SEL2 based on the source output signal SOE triggered by the internal system clock SCLK.

Specifically, as shown in FIG. 9, the first flip-flop FF1 stores the high signal of the source output signal SOE, and generates the second selection signal SEL2 based on the high signal of the source output signal SOE triggered by a rising edge of the internal system clock SCLK. At this time, since the second selection signal SEL2 is a signal generated by triggering the first flip-flop FF1 by the rising edge of the internal system clock SCLK, it may be a signal obtained by delaying the source output signal SOE by 2 bytes (20 UI), that is, 1.0 cycle of the source output signal SOE.

As shown in FIG. 7, the second latch LAT2 stores the second selection signal SEL2 received from the first flip-flop FF1, and generates a third selection signal SEL3 based on the second selection signal SEL2 triggered by the internal system clock SCLK.

Specifically, as shown in FIG. 9, the second latch LAT2 stores a high signal of the second selection signal SEL2, and generates the third selection signal SEL3 based on the high signal of the second selection signal SEL2 triggered by the falling edge of the internal system clock SCLK. At this time, since the third selection signal SEL3 is a signal generated by triggering the second latch LAT2 by the falling edge of the internal system clock SCLK, it may be a signal obtained by delaying the source output signal SOE by 3 bytes (30 UI), that is, 1.5 cycles of the source output signal SOE.

The second multiplexer M2 outputs any one of the first to third selection signals SEL1, SEL2, and SEL3 respectively received from the first latch LAT1, the first flip-flop FF1, and the second latch LAT2 based on the clock selection signal SOE_CLK_SEL received from the clock training symbol detector 413.

Specifically, as shown in FIG. 9, the second multiplexer M2 outputs the first selection signal SEL1 when the first to second bits from the right (e.g., LSBs) of the clock selection signal SOE_CLK_SEL[1:0] have a value of 1 (10′b00_0000_0001 and 10′b00_0000_0010), outputs the second selection signal SEL2 when the third to seventh bits from the right of the clock selection signal SOE_CLK_SEL[6:2] have a value of 1 (10′b00_0000_0100, 10′b00_0000_1000, 10′b00_0001_0000, 10′b00_0010_0000, and 10′b00_0100_0000), and outputs the third selection signal SEL3 when the eighth to tenth bits from the right of the clock selection signal SOE_CLK_SEL[9:7] have a value of 1 (10′b00_1000_0000, 10′b01_0000_0000, and 10′b10_0000_0000).

For example, as shown in FIG. 9, the second multiplexer M2 of the first data driving circuit 410 outputs the third selection signal SEL3 when the ninth bit from the right of the received clock selection signal SOE_CLK_SEL[8] has a value of 1, and the second multiplexer M2 of the second data driving circuit 420 outputs the second selection signal SEL2 when the seventh bit from the right of the received clock selection signal SOE_CLK_SEL[6] has a value of 1.

As shown in FIG. 7, the second flip-flop FF2 stores any one of the first to third selection signals SEL1 to SEL3 received from the second multiplexer M2, and generates an output clock SYNC_SOE based on the stored selection signal triggered by the rising edge of the synchronization clock SOE_SYNC_CLK received from the first multiplexer M1.

Specifically, the second flip-flop FF2 stores the received selection signal, and generates the output clock SYNC_SOE based on the selection signal triggered by the rising edge of the synchronization clock SOE_SYNC_CLK. At this time, a high signal period prior to the rising edge of the synchronization clock SOE_SYNC_CLK among the high signal period of the selection signal functions as a setup time, which is the minimum time required to keep the data stored immediately before the rising edge of the second flip-flop FF2 unchanged, and a high signal period after the rising edge of the synchronization clock SOE_SYNC_CLK among the high signal period of the selection signal may function as a hold time, which is the minimum time required to keep the data unchanged after the rising edge of the second flip-flop FF2. That is, according to an embodiment of the present disclosure, by securing the setup time and the hold time during which the input value is maintained for a certain period before or after the active edge of the clock, the second flip-flop FF2 is triggered by the rising edge of the synchronization clock SOE_SYNC_CLK to normally generate the output clock SYNC_SOE based on the selection signal.

For example, as shown in FIG. 9, the second flip-flop FF2 of the first data driving circuit 410 stores the high signal of the third selection signal SEL3, and is triggered by the rising edge of the synchronization clock SOE_SYNC_CLK to generate the output signal SYNC_SOE based on the high signal of the third selection signal SEL3. The high signal period (setup time: 8 UI) prior to the rising edge of the synchronization clock SOE_SYNC_CLK among the high signal period of the third selection signal SEL3 functions as a setup time, which is the minimum time required to keep the data stored immediately before the rising edge of the second flip-flop FF2 unchanged, and the high signal period (hold time: 12 UI) after the rising edge of the synchronization clock SOE_SYNC_CLK among the high signal period of the third selection signal SEL3 may function as a hold time, which is the minimum time required to keep the data unchanged after the rising edge of the second flip-flop FF2.

Also, the second flip-flop FF2 of the second data driving circuit 420 stores the high signal of the second selection signal SEL2, and is triggered by the rising edge of the synchronization clock SOE_SYNC_CLK to generate the output signal SYNC_SOE based on the high signal of the second selection signal SEL2. The high signal period (setup time: 14 UI) prior to the rising edge of the synchronization clock SOE_SYNC_CLK among the high signal period of the second selection signal SEL2 functions as a setup time, which is the minimum time required to keep the data stored immediately before the rising edge of the second flip-flop FF2 unchanged, and the high signal period (hold time: 6 UI) after the rising edge of the synchronization clock SOE_SYNC_CLK among the high signal period of the second selection signal SEL2 may function as a hold time, which is the minimum time required to keep the data unchanged after the rising edge of the second flip-flop FF2.

The output controller 414c generates a multiplexer control signal M_Ctrl for outputting the source signal SS according to the output clock SYNC_SOE output from the source output signal synchronizer 414b, and outputs it to the channel 415.

Referring back to FIG. 3, the channel 415 receives the multiplexer control signal M_Ctrl from the output controller 414c, and may output the display data data through a multiplexer (not shown) simultaneously with other data driving circuits according to the multiplexer control signal M_Ctrl.

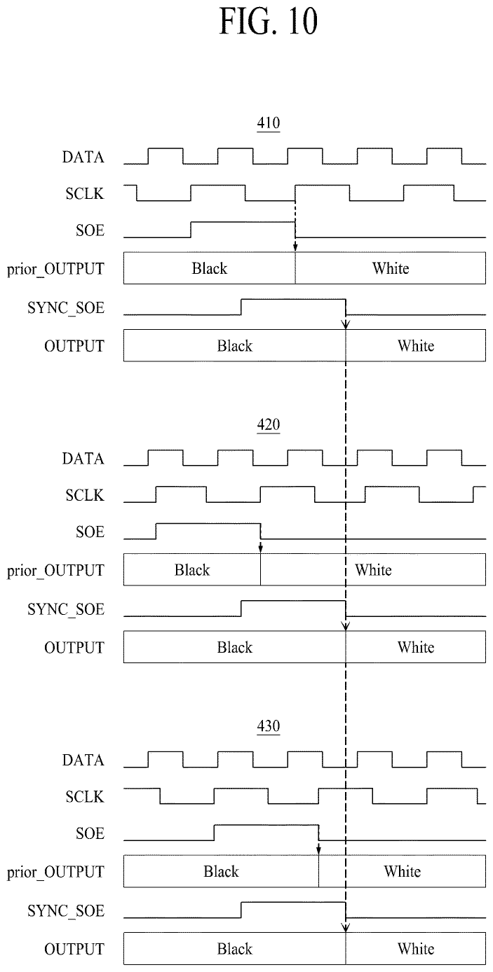

Hereinafter, data input to and output from the conventional data driving device and the data driving device according to an embodiment of the present disclosure will be described with reference to FIG. 10. FIG. 10 is a diagram comparing input and output data for conventional data driving circuits and a data driving circuit according to an embodiment of the present disclosure.

Referring to FIG. 10, a conventional first data driving circuit and the first data driving circuit according to an embodiment of the present disclosure receive the same image data DATA and generate the same internal system clock SCLK. Each of the conventional first to third data driving circuits generates and outputs a source output signal SOE, and an image is output to the display panel 500 according to the source output signal SOE. On the other hand, each of the first to third data driving circuits according to an embodiment of the present disclosure generates and outputs an output clock SYNC_CLK, and an image is output to the display panel 500 according to the output clock SYNC_CLK.

In particular, the data driving circuit according to an embodiment of the present disclosure outputs the output clock SYNC_CLK having the same timing as another data driving circuit in the data driving device, that is, outputting the same signal, so that the source signal can be output simultaneously with the another data driving circuit in the data driving device, thereby improving the image quality of the display panel.

The present disclosure can improve the image quality of a display apparatus by outputting a source signal at the same timing as another data driving circuit in the display apparatus using a timing difference between an internal system clock and display data.

The present disclosure can calculate a timing difference between a start point of a data window where a clock training symbol is detected and an internal system clock by detecting the clock training symbol while moving the data window having a predetermined size in one direction of the display data.

The present disclosure generates an output clock using a signal obtained by delaying a source output signal, thereby securing a setup time and a hold time of a data driving circuit, so that elements included in the data driving circuit can be stably driven.

Those skilled in the art to which the present disclosure pertains will understand that the above-described present disclosure may be implemented in other specific forms without changing its technical spirit or essential features.

Therefore, it should be understood that the embodiments described above are exemplary in all respects and not limiting. The scope of the present disclosure is indicated by the claims to be described later rather than the detailed description, and all changes or modifications derived from the meaning and scope of the claims and their equivalent concepts should be construed as being included in the scope of the present disclosure.

What is claimed is:

1. A data driving device, comprising:
a plurality of data driving circuits,
wherein each of the plurality of data driving circuits includes:
a clock recovery unit configured to recover display data and an internal system clock from image data received from a timing controller, and generate a plurality of candidate reference clocks having a predetermined phase difference using the internal system clock; and
a data processing unit configured to calculate a timing difference between a clock training symbol of the display data and the internal system clock, and generate an output clock synchronized with another data driving circuit based on the calculated timing difference.

2. The data driving device of claim 1, wherein each of the plurality of data driving circuits further includes:
a channel configured to receive the synchronized output clock from the data processing unit and output the display data simultaneously with the other data driving circuit.

3. The data driving device of claim 1, wherein the data processing unit includes:
a clock training symbol detector configured to detect the clock training symbol in the display data while moving a start point of a data window for filtering data with a predetermined size in one direction from a rising edge of the internal system clock, and generate a clock selection signal using a timing difference between the start point of the data window where the clock training symbol is detected and the rising edge of the internal system clock.

4. The data driving device of claim 3, wherein the data processing unit further includes:
a clock synchronizer configured to output a multiplexer control signal to output a source signal simultaneously with another data driving circuit of a display apparatus using the display data, the internal system clock, the clock selection signal, and the plurality of candidate reference clocks.

5. The data driving device of claim 4, wherein the data processing unit further includes:
a source output signal generator configured to generate a source output signal using the display data and the internal system clock; and
a source output signal synchronizer configured to generate a reference clock synchronized with the another data driving circuit using the source output signal, the internal system clock, the clock selection signal, and the plurality of candidate reference clocks.

6. The data driving device of claim 5, wherein the source output signal synchronizer includes:
a first multiplexer configured to output any one of the plurality of candidate reference clocks as a synchronization clock based on the clock selection signal;
a first latch configured to generate a first selection signal delayed by 0.5 cycles of the source output signal;
a first flip-flop configured to generate a second selection signal delayed by 1 cycle of the source output signal;
a second latch configured to generate a third selection signal delayed by 1.5 cycles of the source output signal; and
a second multiplexer configured to output any one of the first to third selection signals based on the clock selection signal.

7. The data driving device of claim 6, wherein the source output signal synchronizer further includes:
a second flip-flop configured to generate an output clock by triggering any one of the first to third selection signals received from the second multiplexer with the synchronization clock received from the first multiplexer.

8. The data driving device of claim 6, wherein
the first selection signal is generated by the first latch triggered by a falling edge of the internal system clock based on the source output signal,
the second selection signal is generated by the first flip-flop triggered by a rising edge of the internal system clock based on the source output signal, and
the third selection signal is generated by the second latch triggered by a falling edge of the internal system clock based on the second selection signal.

9. The data driving device of claim 5, wherein the data processing unit further includes:
an output controller configured to generate a multiplexer control signal according to the synchronized reference clock received from the source output signal synchronizer.

10. The data driving device of claim 9, further comprising:
a channel configured to receive the multiplexer control signal from the output controller and output a source signal.

11. The data driving device of claim 3, wherein each of the data window and the clock training symbol has a size of 20 UI, and the data window filters data while moving by 1 UI in one direction in the display data.

12. A display apparatus, comprising:
a display panel configured to receive a source signal and display an image; and
a data driving device including a plurality of data driving circuits configured to simultaneously supply the source signal to the display panel,
wherein each of the plurality of data driving circuits includes:
a clock recovery unit configured to recover display data and an internal system clock from image data received from a timing controller, and generate a plurality of candidate reference clocks having a predetermined phase difference using the internal system clock; and
a data processing unit configured to calculate a timing difference between a clock training symbol of the display data and the internal system clock, and generate an output clock synchronized with another data driving circuit based on the calculated timing difference.

13. The display apparatus of claim 12, wherein the data processing unit includes:
a clock training symbol detector configured to detect the clock training symbol in the display data while moving a start point of a data window for filtering data with a predetermined size in one direction from a rising edge of the internal system clock, and generate a clock selection signal using a timing difference between the start point of the data window where the clock training symbol is detected and the rising edge of the internal system clock.

14. The display apparatus of claim 13, wherein the data processing unit further includes:
a clock synchronizer configured to output a multiplexer control signal to output a source signal simultaneously with another data driving circuit of the display apparatus using the display data, the internal system clock, the clock selection signal, and the plurality of candidate reference clocks.

15. The display apparatus of claim 14, wherein the data processing unit further includes:
a source output signal generator configured to generate a source output signal using the display data and the internal system clock; and
a source output signal synchronizer configured to generate a reference clock synchronized with the other data driving circuit using the source output signal, the internal system clock, the clock selection signal, and the plurality of candidate reference clocks.

16. The display apparatus of claim 15, wherein the source output signal synchronizer includes:
a first multiplexer configured to output any one of the plurality of candidate reference clocks as a synchronization clock based on the clock selection signal;
a first latch configured to generate a first selection signal delayed by 0.5 cycles of the source output signal;
a first flip-flop configured to generate a second selection signal delayed by 1 cycle of the source output signal;
a second latch configured to generate a third selection signal delayed by 1.5 cycles of the source output signal;
a second multiplexer configured to output any one of the first to third selection signals based on the clock selection signal; and
a second flip-flop configured to generate an output clock by triggering any one of the first to third selection signals received from the second multiplexer with the synchronization clock received from the first multiplexer.

17. The display apparatus of claim 16, wherein
the first selection signal is generated by the first latch triggered by a falling edge of the internal system clock based on the source output signal,
the second selection signal is generated by the first flip-flop triggered by a rising edge of the internal system clock based on the source output signal, and
the third selection signal is generated by the second latch triggered by a falling edge of the internal system clock based on the second selection signal.

18. A data driving circuit, comprising:
a clock recovery unit configured to recover display data and an internal system clock from image data received from a timing controller, and generate a plurality of candidate reference clocks having a predetermined phase difference using the internal system clock;
a data processing unit configured to calculate a timing difference between a clock training symbol of the display data and the internal system clock, and generate a synchronized output clock based on the calculated timing difference; and
a channel configured to receive the synchronized output clock from the data processing unit and output the display data.

19. The data driving circuit of claim 18, wherein the data processing unit includes:
a clock training symbol detector configured to detect a predetermined clock training symbol in the display data, and generate a clock selection signal as information on a timing difference between a start point of the clock training symbol and a rising edge of the internal system clock; and
a clock synchronizer configured to generate the synchronized reference clock based on the clock selection signal.

20. The data driving circuit of claim 19, wherein the clock synchronizer includes:
a source output signal generator configured to generate a source output signal using the display data and the internal system clock;
a source output signal synchronizer configured to generate the synchronized reference clock using the source output signal, the internal system clock, the clock selection signal, and the plurality of candidate reference clocks; and
an output controller configured to generate a multiplexer control signal according to the synchronized reference clock.
